(19) United States
(12) Patent Application Publication
(10) Pub. No.: US 2012/0129067 A1
(43) Pub. Date: May 24, 2012

(54) COOLING WATER SUPPLY SYSTEM AND COOLING WATER SUPPLY METHOD FOR FUEL CELL SYSTEM

(75) Inventors: Gi Young Nam, Yongin (KR); Chi Myung Kim, Yongin (KR); Haeong Jin Ko, Seoul (KR); Seong Kyun Kim, Seoul (KR); Seung Yong Lee, Yongin (KR); Yun Seok Kim, Yongin (KR)

(73) Assignee: HYUNDAI MOTOR COMPANY, Seoul (KR)

(21) Appl. No.: 13/181,862

(22) Filed: Jul. 13, 2011

(30) Foreign Application Priority Data
Nov. 19, 2010 (KR) 10-2010-0115654

(51) Int. Cl. H01M 8/04

(52) U.S. Cl. 429/437

(57) ABSTRACT

The present invention relates to a cooling water supply system and a cooling water supply method for a fuel cell system in which a temperature difference in a fuel cell stack is prevented from increasing due to a rapid increase of a power output required in the stack by detecting a requested/demanded output. According to the present invention, a temperature difference in the stack due to a rapid increase in a power output demanded by the fuel cell stack is prevented from being rapidly increased by detecting a requested output (e.g., an amount an accelerator pedal is pushed, etc.) to calculate a power output required by the stack, calculating a predicted amount of generated heat depending on a required power output, and calculating a flux of supplied cooling water corresponding to the predicted amount of generated heat to control a flow rate of a cooling water supplier.

### CROSS-REFERENCE TO RELATED APPLICATION

This application claims under 35 U.S.C. §119(a) the benefit of Korean Patent Application No. 10-2010-0115654 filed Nov. 19, 2010, the entire contents of which are incorporated herein by reference.

### BACKGROUND

(a) Technical Field

The present disclosure relates to a cooling water supply system and a cooling water supply method for a fuel cell system. More particularly, it relates to a cooling water supply system and a cooling water supply method for a fuel cell system in which a temperature difference in a fuel cell stack is prevented from increasing due to a rapid increase of an output required in the stack by detecting an output demanded by a user.

(b) Background Art

A fuel cell system is configured to separate protons from electrons through a catalytic reaction in an anode where an oxidant (e.g., oxygen) is supplied to a cathode when at the same time a fuel (e.g., hydrogen) is supplied to the anode. In particular, the fuel cell system causes an electrochemical reaction such that electrons are moved from the anode to the cathode via a load after the protons are transferred through a permeable membrane to an air electrode, i.e. the cathode. This reaction thus generates electric energy while the electrons are flowing during the reaction through the load. Notably, in order to apply the fuel cell system to a vehicle as a power source, a fuel cell stack, in which tens or hundreds of unit fuel cells are stacked, is often utilized due to the requirement of a large capacity output.

Naturally, such a fuel cell reaction is accompanied by production of power as well as the production of heat and water at the same time. One problem associated with the heat produced is that a polymer electrolyte membrane in the fuel cell stack can melt above a certain temperature. Also, the water may reduce a transfer efficiency of to hydrogen due to vaporization of moisture inside the fuel cell, resulting in damage to the electrolyte membrane and lowering the energy output of the fuel cell.

In addition, the water produced in the reaction may also fail to be vaporized below a certain temperature of the fuel cell stack so that an excessive amount of water is condensed to be converted into a liquid state, thus blocking a cathode channel and hampering the supply of oxygen, also lowering output of the fuel cell. Therefore, a certain temperature should be maintained for an efficient fuel cell reaction.

To achieve this, current systems attempt to maintain a suitable temperature through a heat/water management system including a cooling water circulating loop though which cooling water can be circulated to the stack using a pump. In this arrangement, temperature of the fuel cell stack rises through heat exchange while the cooling water is passing through the stack, causing a temperature deviation between a cooling water introduced to the stack and cooling water discharged from the stack.

In a conventional technology, in order to reduce a temperature difference of a fuel cell stack, a temperature difference between cooling water introduced to the stack and discharged from the stack is reduced by increasing an amount of supplied cooling water when a measured temperature difference of the stack is above a reference value.

That is, an overall temperature difference of the fuel cell stack is managed by adjusting an amount of supplied cooling water after measuring a temperature difference between a cooling water inlet and a cooling water outlet of the stack while the cooling water is passing through the stack.

However, when a high output is required for a fuel cell stack, since the heat generated due to power generation of the stack is transferred to cooling water and the temperature of cooling water has changed as a result of the heat transfer, i.e. an increased temperature of cooling water is detected, the flow of cooling water is changed, such as by a changed number of rotations of a pump, based on calculations made with reference to the increased temperature of the cooling water.

Accordingly, since a time delay is caused in the processes of transferring the heat generated due to high output generation of the stack and of changing the flow of cooling water (e.g., the number of rotations of the pump to a predetermined value), a temperature difference between the front and rear ends of the stack becomes larger due to rapid generation of heat when the power generated in the stack is rapidly increased, causing lowering of the stack efficiency and potential damage to an electrolyte membrane.

That is, if the amount of supplied cooling water is increased after a temperature difference is measured in response to either the amount of generated power of a fuel cell stack increases or the amount of generated heat increases in the fuel cell stack, there is often a time gap between a point in time when a temperature change in the stack is detected and a point in time when the amount of supplied cooling water increases. Accordingly, this allows for the increase of a temperature difference in the fuel cell stack before the amount of supplied cooling water is actually increased, particularly when the stack output is rapidly increased, and thus lowers the stack efficiency and potentially damages an electrolyte membrane of cells within the fuel cell stack.

### SUMMARY OF THE DISCLOSURE

The present invention has been made in an effort to alleviate the above-described problems associated with prior art, and it is an object of the present invention to provide a cooling water supply system and a cooling water supply method for a fuel cell system in which an overall temperature difference in the stack due to a rapid increase in a power output demanded by the fuel cell stack is prevented from being rapidly increased by detecting a requested output (e.g., an amount an accelerator pedal is pushed, etc.) to calculate the power output required by the stack, calculating a predicted amount of generated heat depending on the required power output, and calculating a flux of supplied cooling water corresponding to the predicted amount of generated heat to control a cooling water supplier.

In one aspect, the present invention provides a cooling water supply method for a fuel cell system comprising the steps of: measuring a requested output (e.g., by a user's demand) that results in a change in stack power output; calculating a required power output of a fuel cell stack based on the measured requested output; calculating a predicted amount of heat in the stack depending on the calculated required power output; calculating a flux of supplied cooling water corresponding to the calculated predicted amount of generated heat; and controlling a cooling water supplier corresponding to the calculated flux of supplied cooling water.

In another aspect, the present invention provides a cooling water supply method for a fuel cell system comprising the steps of: measuring a requested output (e.g., demanded by a user) that results in a change in stack power output; calculating a required power output of a fuel cell stack based on the measured requested output; calculating a predicted amount of heat generated in the stack depending on the calculated required power output; measuring a temperature of cooling water (e.g., with a cooling water temperature sensor mounted to the stack); comparing the calculated predicted amount of generated heat and the measured temperature of cooling water with a pre-established map; and controlling a cooling water supplier based on data of the pre-established map.

The requested output may be based on an amount an accelerator pedal is pushed (depressed) by a user.

The required power output of the stack and the predicted amount of generated heat may be calculated by a high level controller, for example, based on an amount an accelerator pedal is pushed (e.g., from a pushing amount sensor) and a speed of the vehicle (e.g., from a signal of a speed sensor).

A flow rate (e.g., an RPM of a pump) of the cooling water supplier may be controlled with reference to the measured requested output, particularly when a gradient of the measured requested output is above a reference value.

A cooling water temperature sensor may be mounted to an outlet end of the fuel cell stack such that if the temperature of cooling water measured by the cooling water temperature sensor is determined to be above a top limit temperature (T1), the flow rate (e.g., RPM) of the cooling water supplier is controlled to increase to a designated flow rate to rapidly cool the stack.

A cooling water temperature sensor may be mounted to an outlet end of the fuel cell stack such that if the temperature of cooling water measured by the cooling water temperature sensor is determined to be below a bottom limit temperature (T1), the flow rate (e.g., RPM) of the cooling water supplier is controlled to decrease to a designated flow rate.

In still another aspect, the present invention provides a cooling water supply system for a fuel cell system having a fuel cell stack, an air supplier configured to supply air to the stack, and a cooling water supplier configured to supply cooling water to the stack, the system comprising: a requested output sensor configured to measure an output requested by a user; a cooling water supply controller configured to determine a required power output and a predicted amount of generated heat based on the measured requested output, to calculate a flux of supplied cooling water corresponding to the calculated predicted amount of generated heat, and to control a flow rate of the cooling water supplier corresponding to the calculated flux of supplied cooling water; and a cooling water temperature sensor mounted to an inlet end or an outlet end of the stack and configured to measure the temperature of cooling water.

The requested output sensor may include an accelerator pedal pushing amount sensor and a speed sensor.

According to the present invention, when an output of a stack increases instantaneously, a temperature difference between an inlet end and an output end of the stack is prevented from being rapidly increased by increasing an amount of cooling water supplied to the stack in advance.

That is, a temperature difference in the stack due to a rapid increase in an output demanded by the fuel cell stack is prevented from being rapidly increased by detecting a requested output (a pushing amount of an accelerator pedal, etc.) required by a user and calculating a power output required by the stack, and calculating a predicted amount of generated heat and a flux of supplied cooling water depending on the required power output to control the flow rate of a cooling water supplier.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a block diagram illustrating a cooling water supply system for a fuel cell system according to the present invention;

FIG. 2 is a flowchart illustrating a cooling water supply method for a fuel cell system according to an embodiment of the present invention; and

FIG. 3 is a flowchart illustrating another cooling water supply method for a fuel cell system according to an embodiment of the present invention.

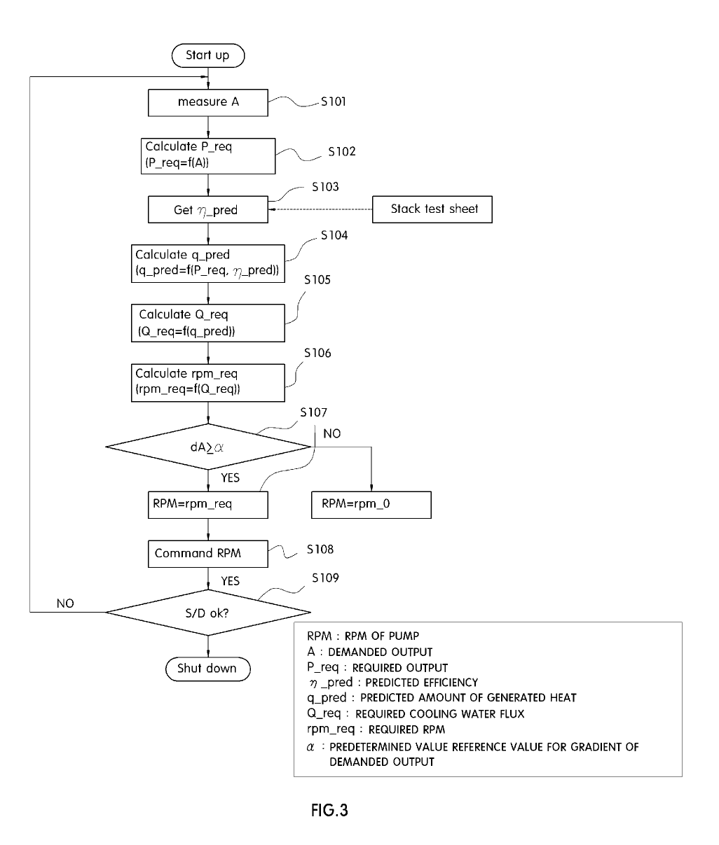

### DETAILED DESCRIPTION

Hereinafter, exemplary embodiments of the present invention will be described below in detail with reference to the accompanying drawings such that those skilled in the art to which the present invention pertains can easily practice the present invention.

Also, it is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

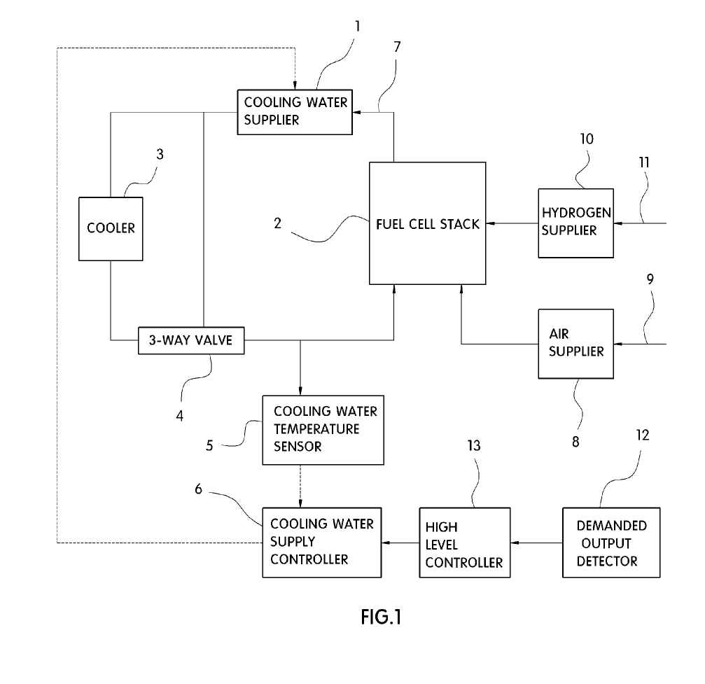

Referring to FIG. 1, an air supply system including an air supplier 8 and an air supply line 9 and a hydrogen supply system including a hydrogen supplier 10 and a hydrogen supply line 11 are connected to a fuel cell stack 2, and a heat/water management system including a cooling water circulating line 7 is connected to the fuel to cell stack 2.

In the heat/water management system, a valve (e.g., 3-way valve) 4 and a cooler (e.g. a radiator) 3 are installed in the water cooling circulating line 7 connected to a cooling water inlet of the stack 2, and a cooling water supplier (e.g. a pump) 1 is installed in the cooling water circulating line 7 connected to a cooling water outlet of the stack 2. A cooling water temperature sensor 5 for measuring the temperature of cooling water is mounted to a cooling water inlet end of the stack 2. Note that this arrangement as shown in FIG. 1 is merely an illustrative example.

The heat/water management system includes a controller 6 configured to receive a signal of the cooling water temperature sensor 5 to control the flow rate (e.g., revolutions per minute or “RPM”) of the cooling water supplier 1.

In the air supply system, an air supplier 8 configured to supply air to the stack 2 is mounted to the air supply line 9.

A requested (or demanded) output sensor (e.g. a sensor for detecting a pushing degree (angle) of an accelerator pedal) 12 is connected to an input side of the controller 6.

Hereinafter, cooling water supply techniques according to the embodiments of the present invention based on the illustrative configuration of the fuel cell system will be described in detail.

### Embodiment 1

According to the first embodiment of the present invention, in order to prevent an overall temperature difference in a fuel cell stack from rapidly increasing in the case in which an output from the stack increases rapidly when oxygen and air (including oxygen) are supplied to the stack to produce electric power while generating water and heat, a requested output sensor 12 detects a requested user output demand which will effect a change in stack output. For example, when a user pushes on an accelerator pedal output sensor 12 transmits a signal to a controller 6 which indicates an angle at which the pedal has been decompressed. Additionally, a speed signal detected by a speed sensor and is transmitted as well to the controller 6. Then, after the controller 6 calculates an output requested and calculates a predicted amount of predetermined generated heat depending on the required output and a flux of supplied cooling water corresponding to the predicted amount of generated heat, an revolutions per minute (RPM) of a cooling water supplier 1 corresponding to the calculated flux of supplied cooling water is controlled.

First, an output A demanded by a user who commands a change in stack output is measured (S101) by an angle of an accelerator pedal pushed by the user.

Next, a required output P_req of the fuel cell stack is calculated in a function of the measured demanded output A [P_req=f(A)] (S102), and a predicted stack efficiency (η_pred) is obtained from test sheet data of the stack (S103). By required output it is meant, the output from the stack that is required to meet the demands of the requested output by the user.

Thereafter, the controller 6 that has received a signal of an accelerator pedal pushing amount sensor 12 and a speed signal of a speed sensor calculates a required output and a predicted amount of generated heat.

That is, the predicted amount q_pred of heat generated in the stack is calculated as a function of a required output P_req and a predicted efficiency η_pred of the stack [q_pred=f(P_req, η_pred) (S104), and a cooling water flux Q_req required by the stack is calculated as a function of a predicted amount of heat generated in the stack [Q_req=f(q_pred) (S105).

Then, a required RPM rpm_req of the cooling water supplier 1 is required as a function of a cooling water flux Q_req [rpm_req=f(Q_req)] (S106).

Thus, after a required RPM of the cooling water supplier 1 is determined based on the actual RPM of the cooling water supplier 1 (S107), and the determined command RPM is transmitted to the cooling water supplier 1 (S108).

Accordingly, the cooling water supplier 1 is driven based on the command RPM, and the above-described process is repeated unless the fuel cell stack is determined not to be shut down after a shutdown of the stack is checked (S109).

Meanwhile, when the requested output is rapidly increased, that is, when the controller 6 receives a signal from the accelerator pedal angle sensor and determines that the requested output has increased rapidly, the amount of water supplied to the stack is increased in advance by allowing the controller 6 to control an RPM demanded by the cooling water supplier 1 to increase through the above-described control process.

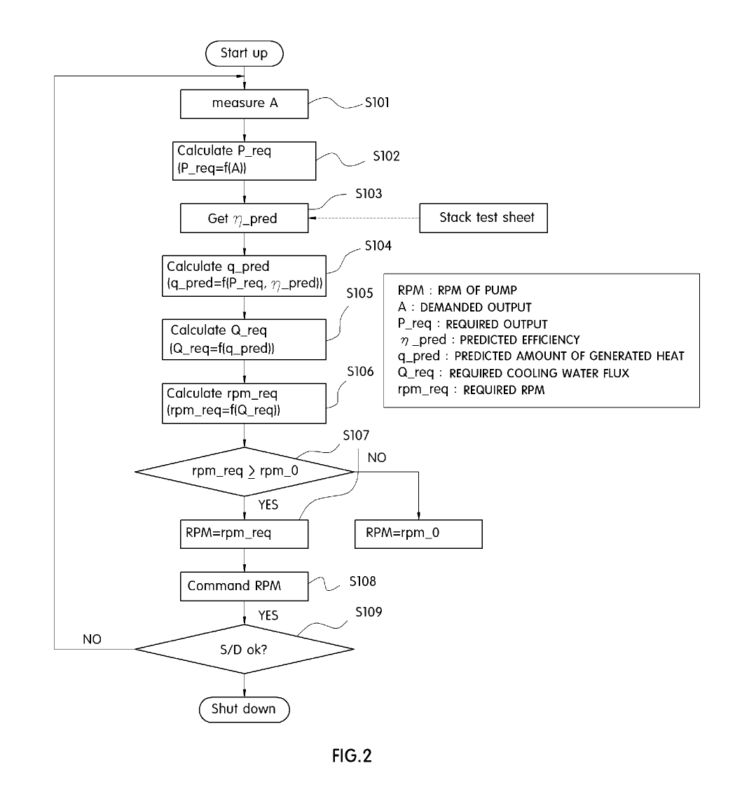

In other words, the RPM of the cooling water supplier 1 is controlled to increase with reference to the requested output by a user who requests a change in the required stack output, in which case only when the measured gradient in the requested output is above a reference value, that is, only when the gradient (dA/dt) in the requested output is larger than a predetermined requested output a in a test as can be seen in S107 of FIG. 2, the RPM of the cooling water supplier 1 is controlled to increase, whereby the stack can be uniformly cooled to reduce a temperature difference of the stack by increasing an amount of cooling water supplied to the stack.

### Embodiment 2

According to the second embodiment of the present invention, in order to prevent an overall temperature difference in a fuel cell stack from rapidly in the case in which the requested output for the stack increases rapidly when oxygen and air (including oxygen) are supplied to the stack to produce electric power while generating water and heat, a current temperature of cooling in the stack and a predicted amount of heat generated in the stack are compared with map data created through a test in advance to determine an RPM of the cooling water supplier based on the map data.

First, after a cooling water temperature sensor 5 mounted to a position where a representative temperature of cooling water in a fuel cell stack, that is, an inlet end or an outlet end of cooling water measures a temperature of cooling water, it transmits a signal to the controller 6.

Then, the controller 6 performs a process of calculating a required output P_req of the fuel cell stack as a function of a requested output A measured as a pushing amount (angle) of an accelerator pedal by a user [P_req-f(A)], a process of obtaining a predicted stack efficiency η_pred from test sheet data of the stack, and a process of calculating a predicted amount q_pred of heat generated in the stack as a function of a required output of the stack P_req and a predicted stack efficiency η_pred [q_pred=f(P_req, η_pred)].

Then, after the high level controller 13 compares a temperature of cooling water and a predicted amount of heat generated in the stack with data of a map created through a test in advance and selects an RPM of the cooling water supplier 1 from the precreated map data, it transmits the selected RPM command value of the cooling water supplier to the controller 6 to control the RPM of the cooling water supplier 1 by the controller 6.

Then, if the requested output requested from the stack increases to thereby increase a temperature of cooling water and a predicted amount of heat generated in the stack, the cooling water supply controller 6 controls the required RPM of the cooling water supplier 1 to increase through the map data comparison control such that an amount of cooling water supplied to the stack is increased to reduce the overall temperature difference by uniformly cooling the stack.

When supply of cooling water is controlled according to the first and second embodiments of the present invention as described above, if a temperature of cooling water measured by a cooling water temperature sensor mounted to a position where a representative temperature of cooling water can be measured, and preferably to a cooling water outlet end of a stack is determined to be above a top limit temperature T1, the stack 2 needs to be rapidly cooled, in which case an RPM of a cooling water supplier 1 is increased regardless of the requested output by the stack to rapidly cool the stack, making it possible to increase the amount of cooling water to the stack and rapidly cool the stack.

Meanwhile, When supply of cooling water is controlled according to the first and second embodiments of the present invention, if a temperature of cooling water measured by a cooling water temperature sensor mounted to a position where a representative temperature of cooling water can be measured, preferably to a cooling water outlet end of a stack is determined to be above a bottom limit temperature T2, the temperature of the stack 10 is low as in a winter season, in which case an RPM of the cooling water supplier 1 may be reduced to a designated RPM.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents. Further, many modifications may be made to specific situations and materials without departing from the essence of the invention. Therefore, the present to invention is not limited to the detailed description of the preferred embodiments but include all embodiments within the scope of the attached claims.

What is claimed is:

1. A cooling water supply method for a fuel cell system comprising:
measuring, by a first sensor, a requested output by a user who demands a change in stack output;
calculating, by a controller, a required output of a fuel cell stack based on the measured requested output;
calculating, by the controller, a predicted amount of heat in the stack depending on the calculated required output;
calculating, by the controller, a flux of supplied cooling water corresponding to the calculated predicted amount of generated heat; and
controlling, by the controller, a revolutions per minute (RPM) of a cooling water supplier corresponding to the calculated flux of supplied cooling water.

2. The cooling water supply method of claim 1, wherein the requested output is an angle an accelerator pedal by the user.

3. The cooling water supply method of claim 1, wherein the required output of the stack and the predicted amount of generated heat are calculated based on an angle at which an accelerator pedal is compressed by a pushing amount sensor and a speed signal of a speed sensor.

4. The cooling water supply method of claim 1, wherein the RPM of the cooling water supplier is controlled with reference to the measured requested output only when a gradient of the measured requested output is above a reference value.

5. The cooling water supply method of claim 1, wherein a second sensor is mounted to an outlet end of the stack such that if the temperature of cooling water measured by the second sensor is determined to be above a top limit temperature (T1), the RPM of the cooling water supplier is controlled to increase to a designated RPM to rapidly cool the stack.

6. The cooling water supply method of claim 1, wherein a second sensor is mounted to an outlet end of the stack such that if the temperature of cooling water measured by the second sensor is determined to be below a bottom limit temperature (T1), the RPM of the cooling water supplier is controlled to decrease to a designated RPM.

7. A cooling water supply method for a fuel cell system comprising:
measuring, by a first sensor, a requested output by a user who demands a change in stack output;
calculating, by a controller, a required output of a fuel cell stack based on the measured requested output;
calculating, by the controller, a predicted amount of heat generated in the stack depending on the calculated required output;
measuring, by a second sensor, a temperature difference of cooling water in the stack;
comparing, by the controller, the calculated predicted amount of generated heat and the measured temperature of cooling water with a precreated map; and
controlling, by the controller, a revolutions per minute (RPM) of a cooling water supplier based on data of the precreated map.

8. The cooling water supply method of claim 7, wherein the requested output is an angle an accelerator pedal is compressed by the user.

9. The cooling water supply method of claim 7, wherein the required output of the stack and the predicted amount of generated heat are calculated by a high level controller based on an angle detected by an accelerator pedal pushing amount sensor and a speed signal of a speed sensor.

10. The cooling water supply method of claim 7, wherein revolutions per minute (RPM) of the cooling water supplier is controlled with reference to the measured requested output only when a gradient of the measured requested output is above a reference value.

11. The cooling water supply method of claim 7, wherein the second sensor is mounted to an outlet end of the stack such that if the temperature of cooling water measured by the second sensor is determined to be above a top limit temperature (T1), the RPM of the cooling water supplier is controlled to increase to a designated RPM to rapidly cool the stack.

12. The cooling water supply method of claim 7, wherein the second sensor is mounted to an outlet end of the stack such that if the temperature of cooling water measured by the second sensor is determined to be below a bottom limit temperature (T1), the RPM of the cooling water supplier is controlled to decrease to a designated RPM.

13. A cooling water supply system for a fuel cell system including a fuel cell stack, an air supplier configured to supply air to the stack, and a cooling water supplier configured to supply cooling water to the stack, comprising:
a first sensor configured to measure an output requested by a user;
a controller configured to determine a required output and a predicted amount of generated heat based on the measured requested output, to calculate a flux of supplied cooling water corresponding to the calculated predicted amount of generated heat, and to control a revolutions per minute (RPM) of the cooling water supplier corresponding to the calculated flux of supplied cooling water; and
a second sensor mounted to an inlet end of the stack and a third sensor mounted at the outlet end of the stack, both the second and third sensor configured to measure the temperature of cooling water so as to determine a temperature difference between the inlet of the stack and the outlet of the stack.

14. The cooling water supply system of claim 13, wherein the first sensor includes an accelerator pedal pushing amount sensor and a speed sensor.
